(19) United States
(12) Patent Application Publication
(10) Pub. No.: US 2006/0081228 A1
(43) Pub. Date: Apr. 20, 2006

(54) Exhaust gas recirculation valve and poppet

(75) Inventors: Robert D. Keefover, Lake Orion, MI (US); Michael J. Halsig, Warren, MI (US)

Correspondence Address: Patent Docket Administrator;BorgWarner Inc., 3850 Hamlin Road, Auburn Hills, MI, 48326, US

(73) Assignee: BorgWarner Inc., Auburn Hills, MI (US)

(21) Appl. No.: 11/236,393

(22) Filed: Sep. 27, 2005

Related U.S. Application Data
(60) Provisional application No. 60/619,971, filed on Oct. 19, 2004.

(51) Int. Cl. F02M 25/07; F16K 31/02

(52) U.S. Cl. 123/568.23; 251/129.11

(57) ABSTRACT

The present invention is directed to an EGR valve having a housing with a primary passage and a secondary passage. A poppet valve is used to separate or control the flow of fluid from the secondary passage to the primary passage. The valve shaft has a longitudinal axis that extends through the primary passage at a location other than the centerline axis of the primary passage. Additionally, the present invention has a mixing furrow located along the interior surface of the primary passage that will cause gasses flowing from the secondary passage to the primary passage to swirl and mix prior to being introduced to the intake manifold of an engine.

### CROSS-REFERENCE TO RELATED APPLICATION

This application claims the benefit of U.S. Provisional Application No. 60/619,971, filed Oct. 19, 2004. The disclosure of the above application is incorporated herein by reference.

### FIELD OF THE INVENTION

The present invention relates generally to a poppet style exhaust gas recirculation valve having a valve stem that is configured such that its longitudinal axis is significantly offset from the centerline of the intake bore.

### BACKGROUND OF THE INVENTION

Control of exhaust gas flow in an internal combustion engine is commonly used to alter the engine's function or modify its performance. Exhaust gas generated by pistons of an engine is released into its exhaust system during an exhaust cycle. This gas flow may be controlled with the use of various valves positioned and operated in the exhaust system of the engine.

In order to control the flow of gas, exhaust gas recirculation (EGR) valves are used. Such EGR valves include sliding valves, poppet valves, and valve-in-bore systems. Poppet style EGR valves have a face-sealing portion of the valve plate, that is moved away from a sealing surface to open the exhaust flow path. Such valves may provide a fail-safe mode in the event of actuation system failure. However, in the presence of a high-pressure differential across the valve plate, a relatively high actuation system force is generally required to open the valve or keep the valve closed (depending on the exhaust flow direction when the valve is open). Furthermore, poppet valves often result in excessive flow restriction due to the fact that the valve shaft is often disposed through the centerline axis of the intake bore. Additionally, having the valve shaft disposed through the centerline axis of the intake bore also increases packaging size since there is greater distance between the valve shaft and the actuator.

Another problem with poppet style valves is that there is often times an inadequate way of thoroughly mixing the exhaust gas with fresh air prior to combustion. For all of the above reasons it is desirable to provide new poppet style EGR valves that have increased packaging and performance benefits as well as providing the benefit of mixing the exhaust gas with fresh air prior to combustion.

### SUMMARY OF THE INVENTION

The present invention is directed to an EGR valve having a housing with a primary passage and a secondary passage. The primary passage or intake bore is disposed through said housing and permits the flow of fresh air from outside of the vehicle to the intake manifold of an engine. The primary passage has a lateral or centerline axis. The secondary passage is configured to communicate with the primary passage. The secondary passage permits the flow of exhaust gas from the exhaust system into the primary passage where the exhaust gas is combined with fresh air prior to entering the intake manifold. A valve seat is disposed radially within the secondary passage. A poppet valve is disposed within the secondary passage for selectively restricting the flow of fluid from the secondary passage to the primary passage by contacting the valve seat. An actuator is connected to the housing of the EGR valve and controls the movement of the poppet valve relative to the valve seat. A valve shaft is connected at a first end to the poppet valve and at a second to the actuator. The valve shaft has a longitudinal axis that extends through the primary passage at a location other than the centerline axis of the primary passage. In other words, the valve shaft will be offset from the centerline of the primary passage or intake bore.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective side view of the EGR valve showing both the primary and secondary passages;

FIG. 2 is a cross-sectional side plan view of the EGR valve taken about section line 2-2 in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

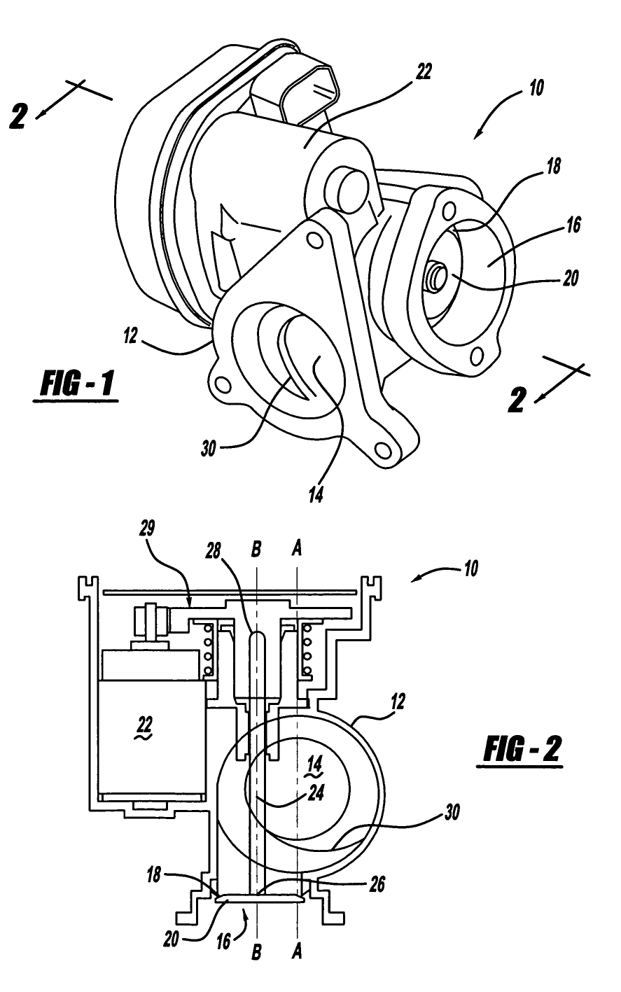

Referring to FIGS. 1 and 2 which depict various views of an exhaust gas recircuation (EGR) valve 10 having a housing 12 for containing the various components of the EGR valve 10. The housing can be a separate component or the housing can be integrally formed in the intake manifold. A primary passage 14 is disposed through the housing 12 to direct the flow of fresh air taken in from outside of the vehicle to the engine's intake manifold in order to provide fresh air for combustion. The primary passage 14 has a lateral or centerline axis A-A that defines the centerline of the primary passage 14.

A secondary passage 16 extends through the housing 14 and connects to the primary passage 14 at a generally perpendicular angle. However, it is within the scope of this invention to configure the valve so the secondary passage does not connect at a perpendicular angle. The secondary passage 16 permits the flow of exhaust gas being recirculated from the exhaust system to the primary passage 14 where the exhaust gas is mixed with the fresh air and is presented to the intake manifold of the engine for combustion. At certain times during the engine cycle it is not desirable to recirculate the exhaust gas; therefore, it may be necessary to block the flow of exhaust gas through the secondary passage 16. Additionally, it is also desirable to control the amount of exhaust gas being permitted to enter into the primary passage 14 since certain engine conditions may require different compositions or ratios of fresh air to exhaust gas in order to optimize combustion. In order to control the flow of exhaust gas through the secondary passage 16 there is a valve seat 18 that is formed along the interior surface of the secondary passage 16. A poppet valve 20 is disposed and configured to interact with a the valve seat 18 in order for the poppet valve to move from a fully closed position, wherein the poppet valve 20 is positioned against the valve seat 18 to a fully opened position where the poppet valve 20 is moved to a distance that is further away from the valve seat 18. In order to facilitate the movement of the poppet valve 20, a valve shaft 24 is connected to the poppet valve 20 at a first end 26 of the valve shaft 24. The valve shaft 24 has a longitudinal axis B-B that extends through the primary passage 14 to a second end 28 of the valve shaft 24 that is connected to a gear train 29. The gear train 29 is connected to an actuator 22 that is connected to the housing 12 of the EGR valve 10. The actuator 22 in combination with the gear train 29 and the valve shaft 24 causes the valve shaft 24 to move along its longitudinal axis B-B in order to move the poppet valve 20 between the open and closed positions, as well as any intermediate position in order to control the amount of exhaust gas flowing through the secondary passage 16. While the present embodiment describes an actuator arrangement that uses a gear train and motor, it is within the scope of this invention for other suitable actuator mechanism to be used that will facilitate the movement of the valve.

One desirable feature of the present invention is the position of the valve shaft 24. As can be seen in both FIG. 2, the longitudinal axis B-B of the valve shaft 24 is positioned at a distance away from the centerline axis A-A of the primary passage 14. Positioning the valve shaft 24 at a location other than the centerline axis A-A of the primary passage 14 decreases the restriction of airflow through the primary passage 14 since the valve shaft 24 is located near the side of the primary passage 14 which will cause less restriction of airflow. Additionally, positioning the valve shaft 24 closer to the side of the primary passage 14 will allow the valve shaft 24 to be located closer to the actuator 22. This provides an advantage of reducing the gear ratios needed in the gear train 29. The result is that the actuator will require less power 22 in order to move the valve shaft 24. Additionally, the response time of the movement of the poppet valve 20 will be reduced since a smaller gear ratio in the gear train 29 will reduce response time.

Another feature of the invention shown in FIGS. 1 and 2 includes a mixing furrow 30 that is disposed along the interior surface of the primary passage 14 adjacent the location where the secondary passage 16 connects to the primary passage 14. As exhaust gas enters from the secondary passage 16 it will enter the primary passage 14 at a generally perpendicular angle to the flow of the fresh air flowing through the primary passage 14. Therefore, it is desirable to try to ensure that the fresh air and exhaust gas will mix thoroughly before being introduced to the intake manifold of the vehicle engine. The mixing furrow 30 ensures that the fresh air and exhaust gas will be thoroughly mixed prior to combustion. The mixing furrow 30 functions to cause the exhaust gas entering from the secondary passage 16 to the primary passage 14 to swirl as it travels along the channel formed by the mixing furrow 30. The end result is that the air entering the intake manifold of the vehicle engine will be more thoroughly mixed as a result of the swirling action created by the mixing furrow 30.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A valve comprising:
a housing;
a primary passage disposed through said housing, said primary passage having a centerline axis;
a secondary passage communicating with said primary passage;
a valve member operably configured to control the flow of fluid medium between said primary passage and said secondary passage, wherein said valve member has a longitudinal axis that is at a location other than said centerline axis of said primary passage; and
a mixing furrow formed in said primary passage.

2. The valve of claim 1 further comprising one or more gears having a gear ratio operably connected between an actuator and said valve member, wherein said one or more gears facilitate the movement of said valve member between an open and closed position.

3. The valve of claim 1 wherein said secondary passage connects to said primary passage at a generally perpendicular angle.

4. The valve of claim 1 wherein said valve member is a poppet valve member having a valve seat formed in said housing and a valve shaft having a first end connected to a poppet valve, wherein said valve shaft has a longitudinal axis that extends through the primary passage at a location other than said centerline axis of said primary passage and said valve shaft is configured to slide along its longitudinal axis to facilitate the movement of said poppet valve with respect to said valve seat.

5. The valve of claim 1 wherein said mixing furrow is a groove or recess formed along the circumferential surface of said primary passage, wherein said mixing furrow causes a swirling effect that mixes said fluid media moving through said secondary passage with fluid media moving through said primary passage.

6. A valve comprising:
a housing;
an primary passage disposed through said housing, said primary passage having a centerline axis;
a secondary passage communicating with said primary passage;
a valve seat disposed radially within the secondary passage;
a poppet valve disposed within said secondary passage and engageable with said valve seat for selectively restricting the flow of fluid from the secondary passage to the primary passage;
an actuator for controlling the movement of said poppet valve; and
a valve shaft connected at a first end to said poppet valve and a second end being operably connected to said actuator, wherein a longitudinal axis of said valve shaft extends through said primary passage at a location other than said centerline axis of said primary passage.

7. The valve of claim 6 further comprising a mixing furrow formed in said primary passage.

8. The valve of claim 7 wherein said mixing furrow is a groove or recess formed along the circumferential surface of said primary passage, wherein said mixing furrow causes a swirling effect that mixes said fluid media moving through said secondary passage with fluid media moving through said primary passage.

9. The valve of claim 6 further comprising one or more gears having a gear ratio connected between said actuator and said poppet valve shaft, wherein said one or more gears facilitate the movement of said poppet valve shaft.

10. The valve arrangement of claim 6 wherein said secondary passage connects to said primary passage at a generally perpendicular angle.

11. A valve comprising:
a housing;
a primary passage disposed through said housing, said primary passage having a centerline axis;
a secondary passage communicating with said primary passage; and
a poppet valve member operably configured to control the flow of fluid medium between said primary passage and said secondary passage, wherein said poppet valve member has a longitudinal axis that is at a location other than said centerline axis of said primary passage between said centerline of said primary passage and the side wall of said primary passage.

12. The valve of claim 11 further comprising one or more gears having a gear ratio operably connected between an actuator and said poppet valve member, wherein said one or more gears facilitate the movement of said poppet valve member between an open and closed position.

13. The valve of claim 11 wherein said secondary passage connects to said primary passage at a generally perpendicular angle.

14. The valve of claim 11 wherein said poppet valve member has a valve seat formed in said housing and a valve shaft having a first end connected to said poppet valve member, wherein said valve shaft has a longitudinal axis that extends through the primary passage at a location other than said centerline axis of said primary passage and said valve shaft is configured to slide along its longitudinal axis to facilitate the movement of said poppet valve member with respect to said valve seat.

15. The valve of claim 11 further comprising a mixing furrow in said primary passage, wherein said mixing furrow is a groove or recess formed along the circumferential surface of said primary passage and causes a swirling effect that mixes said fluid media moving through said secondary passage with fluid media moving through said primary passage.
